(19) United States
(12) Patent Application Publication
(10) Pub. No.: US 2023/0385647 A1
(43) Pub. Date: Nov. 30, 2023

(54) METHOD FOR TRAINING A NEURAL NETWORK WITH FLEXIBLE FEATURE COMPRESSION CAPABILITY, AND NEURAL NETWORK SYSTEM WITH FLEXIBLE FEATURE COMPRESSION CAPABILITY

(71) Applicant: National Tsing Hua University, Hsinchu City (TW)

(72) Inventors: Chung-Yueh Liu, Hsinchu City (TW); Yu-Chih Tsai, Hsinchu City (TW); Ren-Shuo Liu, Hsinchu City (TW)

(73) Assignee: National Tsing Hua University, Hsinchu City (TW)

(21) Appl. No.: 18/323,048

(22) Filed: May 24, 2023

Related U.S. Application Data
(60) Provisional application No. 63/345,918, filed on May 26, 2022.

(51) Int. Cl. G06N 3/084; G06N 3/0464

(52) U.S. Cl. CPC G06N 3/084; G06N 3/0464

(57) ABSTRACT

A neural network is provided to include a layer that has a weight set. The neural network is trained based on a first compression quality level, where the weight set and a first set of batch normalization coefficients are used in said layer, so the weight set and the first set of batch normalization coefficients are trained with respect to the first compression quality level. Then, the neural network is trained based on a second compression quality level, where the weight set that has been trained with respect to the first compression quality level and a second set of batch normalization coefficients are used in said layer, so the weight set is trained with respect to both of the first and second compression quality levels, and the second set of batch normalization coefficients is trained with respect to the second compression quality level.

### CROSS-REFERENCE TO RELATED APPLICATION

This application claims the benefits of U.S. Provisional Patent Application No. 63/345,918, filed on May 26, 2022, which is incorporated by reference herein in its entirety.

### FIELD

The disclosure relates to a neural network, and more particularly to a neural network with flexible feature compression capability.

### BACKGROUND

An artificial neural network (or simply “neural network”) is usually composed of multiple layers of artificial neurons. Each layer may perform a transformation on its input, and generate an output that serves as an input to the next layer. As an example, a convolutional neural network includes a plurality of convolutional layers, each of which may include multiple kernel maps and a set of batch normalization coefficients to perform convolution and batch normalization on an input feature map, and generate an output feature map to be used by the next layer.

However, memory capacity of a neural network accelerator is usually limited and insufficient to store all of the kernel maps, the sets of batch normalization coefficients and the feature maps that are generated during operation of the neural network, so external memory is often used to store these data. Accordingly, the operation of the neural network would involve a large amount of data transfer between the neural network accelerator and the external memory, which would result in power consumption and latency.

### SUMMARY

Therefore, an object of the disclosure is to provide a method for training a neural network, such that the neural network has flexible feature compression capability.

According to the disclosure, the neural network includes multiple neuron layers, one of which includes a weight set and has a data compression procedure that uses a data compression-decompression algorithm. The method includes steps of: A) by a neural network accelerator, training the neural network based on a first compression setting that corresponds to a first compression quality level, where a first set of batch normalization coefficients that corresponds to the first compression quality level is used in said one of the neuron layers during the training of the neural network in step A); B) by the neural network accelerator, outputting the weight set (optional) and the first set of batch normalization coefficients that have been trained in step A) for use by the neural network when the neural network is executed to perform decompression and multiplication-and-accumulation on a to-be-processed compressed feature map substantially based on the first compression quality level in said one of the neuron layers; C) by the neural network accelerator, training the neural network based on a second compression setting that corresponds to a second compression quality level different from the first compression quality level, where the weight set that has been trained in step A) and a second set of batch normalization coefficients that corresponds to the second compression quality level are used in said one of the neuron layers during the training of the neural network in step C); and D) by the neural network accelerator, outputting the weight set that has been trained in both of step A) and step C) for use by the neural network when the neural network is executed to perform decompression and multiplication-and-accumulation on the to-be-processed compressed feature map substantially based on any one of the first compression quality level and the second compression quality level in said one of the neuron layers, and the second set of batch normalization coefficients that has been trained in step C) for use by the neural network when the neural network is executed to perform decompression and multiplication-and-accumulation on the to-be-processed compressed feature map substantially based on the second compression quality level in said one of the neuron layers. At least one of the first compression quality level or the second compression quality level is a lossy compression level.

Another object of the disclosure is to provide a neural network system that has flexible feature compression capability. The neural network system includes a neural network accelerator and a memory device. In some embodiments, the neural network accelerator is configured to execute the neural network that has been trained using the method of this disclosure. The memory device is accessible to the neural network accelerator, and stores the weight set which has been trained in the method, the first set of batch normalization coefficients which has been trained in the method, and the second set of batch normalization coefficients which has been trained in the method. The neural network accelerator is configured to (a) select one of the first compression quality level and the second compression quality level for said one of the neuron layers, (b) store into said memory device a compressed input feature map that corresponds to said one of the neuron layers and that was compressed with the selected one of the first compression quality level and the second compression quality level, (c) load the compressed input feature map from said memory device for said one of the neuron layers, (d) decompress the compressed input feature map with respect to the selected one of the first compression quality level and the second compression quality level to obtain a decompressed input feature map, (e) load the weight set from said memory device, (f) use the weight set to perform an operation of multiplying and accumulating on the decompressed input feature map to generate a computed feature map, (g) load one of the first set of batch normalization coefficients and the second set of batch normalization coefficients that corresponds to the selected one of the first compression quality level and the second compression quality level from said memory device, and (h) use the loaded one of the first set of batch normalization coefficients and the second set of batch normalization coefficients to perform batch normalization on the computed feature map to generate a normalized feature map for use by the next neuron layer.

In some embodiments, the neural network accelerator is configured to cause a neural network that includes multiple neuron layers to perform corresponding operations. The memory device is accessible to the neural network accelerator, and stores a weight set corresponding to one of the neuron layers, and multiple sets of batch normalization coefficients corresponding to said one of the neuron layers. The weight set is adapted to multiple compression quality levels, and each of the sets of batch normalization coefficients is adapted for a respective one of the compression quality levels. The neural network accelerator is configured to (a) select one of the compression quality levels for said one of the neuron layers, (b) store into said memory device a compressed input feature map that corresponds to said one of the neuron layers and that was compressed with the selected one of the compression quality levels, (c) load the compressed input feature map from said memory device for said one of the neuron layers, (d) decompress the compressed input feature map with respect to the selected one of the compression quality levels to obtain a decompressed input feature map, (e) load the weight set from said memory device, (f) use the weight set to perform an operation of multiplying and accumulating on the decompressed input feature map to generate a computed feature map, (g) load one of the sets of batch normalization coefficients that is adapted for the selected one of the compression quality levels from said memory device, and (h) use the loaded one of the sets of batch normalization coefficients to perform batch normalization on the computed feature map to generate a normalized feature map for use by a next neuron layer, which is one of the neuron layers that immediately follows said one of the neuron layers.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating a convolutional neural network.

FIG. 2 is a block diagram illustrating an embodiment of a neural network system according to this disclosure.

FIG. 3 is a block diagram illustrating that the embodiment includes multiple sets of batch normalization coefficients that respectively correspond to multiple compression quality levels for a single layer.

FIG. 4 is a flow chart illustrating operation of the embodiment.

FIG. 5 is a flow chart illustrating an embodiment of a method for training a neural network according to this disclosure.

FIG. 6 is a block diagram illustrating the embodiment of the method for training the neural network in more detail.

FIG. 7 is a block diagram illustrating a bottleneck residual block of a MobileNet architecture.

FIG. 8 is a block diagram illustrating a scenario where the embodiment of the neural network system is implemented in the bottleneck residual block of the MobileNet architecture.

FIG. 9 is a block diagram illustrating a ResNet architecture.

FIG. 10 is a block diagram illustrating a scenario where the embodiment of the neural network system is implemented in a part of the ResNet architecture.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

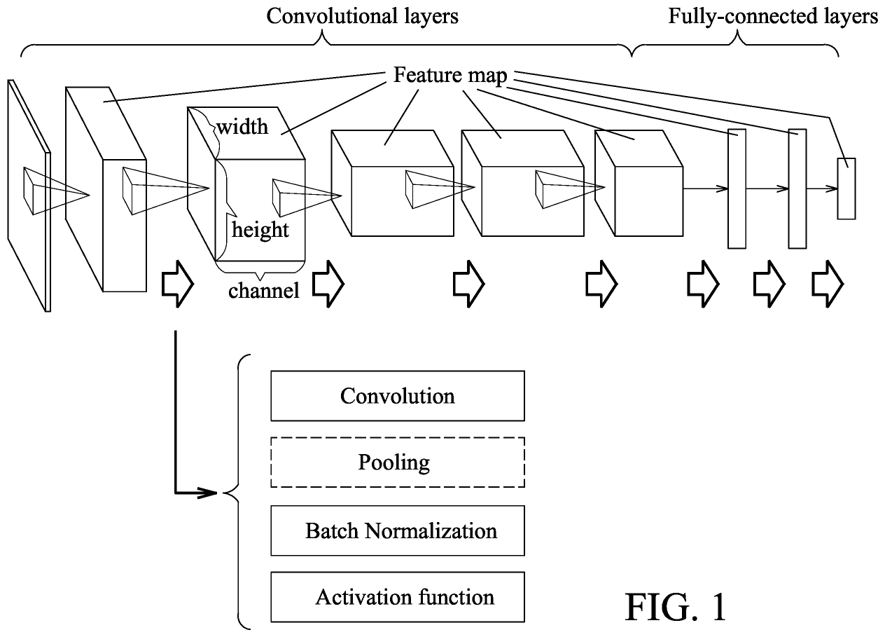

Referring to FIG. 1, a neural network is illustrated to include multiple neuron layers, each performing a transformation on its input to generate an output, where the neural network may be configured for, for example, artificial intelligence (AI) de-noising, AI style transfer, AI temporal super resolution, AI spatial super resolution, or AI image generation, etc., but this disclosure is not limited in this respect. The neuron layers may include multiple computational layers. Each computational layer outputs a feature map (also called “activation map”) that serves as an input to the next layer. In some embodiments, each computational layer may perform an operation of multiplying and accumulating (e.g., convolution), pooling (optional), batch normalization (BN) and an activation operation on an input feature map. The pooling operation may be omitted, and a computational layer uses one or more weights (referred to as “weight set” hereinafter, noting that sometimes the term “weight” may be interchangeable with “kernel,” for example, in a convolutional neural network) to perform the operation of multiplying and accumulating on the input feature map to generate a computed feature map (where the number of the weight(s) in the weight set corresponds to the number of channels of the computed feature map), uses a set of BN coefficients to perform batch normalization on the computed feature map to generate a normalized feature map, and then uses an activation function to process the normalized feature map to generate an output feature map, which serves as an input feature map to the next layer. In this embodiment, the neural network is exemplified as, but not limited to, a convolutional neural network (CNN), and the neuron layers of the CNN may include multiple convolutional layers (namely, the aforesaid computational layers) and optionally one or more fully-connected (FC) layers that are connected one by one. Each of the convolutional layers and the FC layers outputs a feature map (also called “activation map”) that serves as an input to the next layer. In the illustrative embodiment, each of the convolutional layers performs convolution (corresponding to the aforesaid operation of multiplying and accumulating), pooling (optional), batch normalization (BN) and activation operation on an input feature map. In this embodiment, the pooling operation is omitted, and a convolutional layer uses one or more kernel maps (referred to as “kernel map set” hereinafter in the illustrative embodiment) to perform convolution on the input feature map to generate a convolved feature map (i.e., the aforesaid computed feature map) (where the number of the kernel map(s) in the kernel map set corresponds to the number of channels of the convolved feature map), uses a set of BN coefficients to perform batch normalization on the convolved feature map to generate a normalized feature map, and then uses an activation function to process the normalized feature map to generate an output feature map, which serves as an input feature map to the next layer. The set of BN coefficients may include a set of scaling coefficients and a set of offset coefficients. During the batch normalization, the convolved feature map may be normalized using its average and standard deviation to obtain a preliminarily normalized feature map in a first step. Subsequently, elements of the preliminarily normalized feature map may be multiplied with the scaling coefficients and then added by the offset coefficients to obtain the aforesaid normalized feature map. In other words, the batch normalization may include steps of normalization, scaling, and offset.

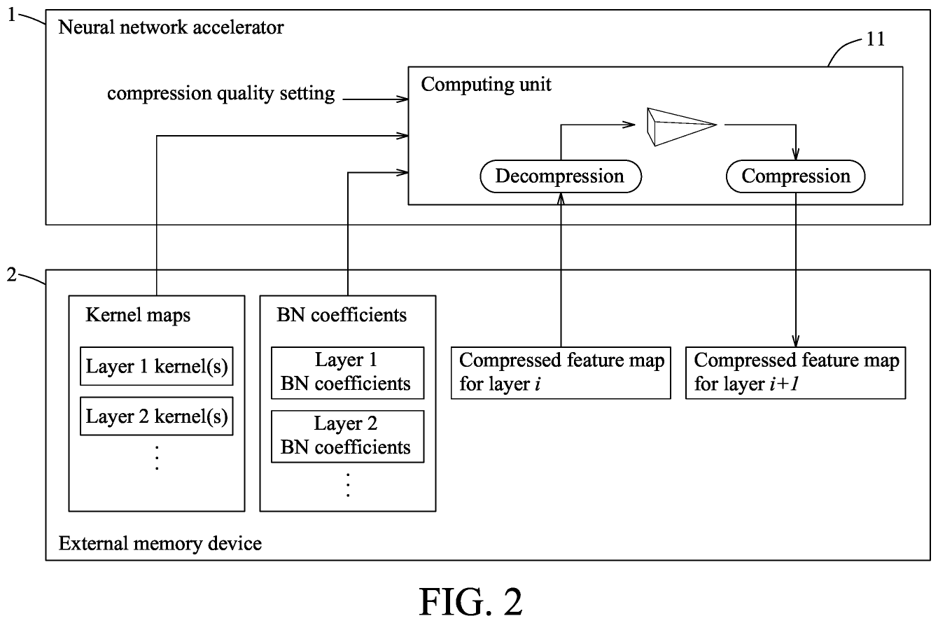

Referring to FIG. 2, an embodiment of a neural network system with flexible feature compression capability according to this disclosure is shown to include a neural network accelerator 1 (referred to as accelerator 1 hereinafter), and a memory device 2 that is physically separate from and electrically connected to the accelerator 1. The accelerator 1 may be realized using, for example, a graphics processing unit (GPU), a field-programmable gate array (FPGA), an application-specific integrated circuit (ASIC), etc., and this disclosure is not limited in this respect. The accelerator 1 includes a computing unit 11 to perform the abovementioned convolution, batch normalization and activation function. The computing unit 11 may include, for example, a processor core, a convolver circuit, registers, etc., but this disclosure is not limited in this respect. The memory device 2 may be realized using, for example, static random access memory (SRAM), dynamic random access memory (DRAM), synchronous dynamic random-access memory (SDRAM), synchronous graphics random-access memory (SGRAM), high bandwidth memory (HBM), flash memory, solid state drives, hard disk drives, other suitable memory devices, or any combination thereof, but this disclosure is not limited in this respect. The term “memory device” is a general idea and does not necessarily mean homogeneous and monolithic memory. In some embodiments, the memory device 2 may include one or more on-chip memory arrays. In some embodiments, the memory device 2 may include one or more external memory chips. In some examples, the memory device 2 may be distributed in a neural network system. In the illustrative embodiment, the memory device 2 is an external memory device that includes one or more external memory chips, but this disclosure is not limited in this respect. Because of limited memory capacity of the accelerator 1, the kernel map set (named “Layer i kernel(s)” in FIG. 2), the BN coefficients and the output feature map of each of the convolutional layers are stored in the external memory device 2. When the accelerator 1 causes one of the convolutional layers (e.g., a layer “i”, where i is a positive integer) to perform corresponding operations, the accelerator 1 loads the corresponding kernel map set, BN coefficients and feature map from the external memory device 2.

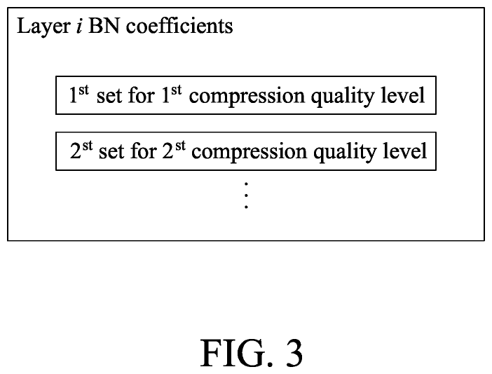

In this embodiment, the computing unit 11 compresses the output feature map for one or more neuron layers, so as to reduce data transfer between the accelerator 1 and the external memory device 2, and power consumption and latency of the neural network can thus be reduced. Furthermore, the computing unit 11 is configured to selectively use, for each neuron layer that is configured to compress the output feature data, one of multiple predetermined compression quality levels to perform the data compression, and the BN coefficients that correspond to the neuron layer includes multiple sets of BN coefficients that have been trained respectively with respect to the multiple predetermined compression quality levels, as shown in FIG. 3. Different compression quality levels correspond to different compression ratios, respectively. Usually, a higher compression quality level corresponds to a smaller compression ratio. The computing unit 11 may make the selection of the predetermined compression quality level based on a compression quality setting that is determined by a user, or based on various operation conditions of the neural network system, such as a work load of the accelerator 1 (e.g., selecting a lower compression quality when the work load is heavy), a temperature of the accelerator 1 (which can be acquired using a temperature sensor) (e.g., selecting a lower compression quality when the temperature is high), a battery level (when power of the neural network system is supplied by a battery device) (e.g., selecting a lower compression quality when the battery level is low), available storage space of the memory device 2 (e.g., selecting a lower compression quality when the available storage space is small), available bandwidth of the memory device 2 (e.g., selecting a lower compression quality when the available bandwidth is narrow), a length of time set for completing a task to be done by the neural network (e.g., selecting a lower compression quality when the length of time thus set is short), a type of a task to be done by the neural network (e.g., selecting a lower compression quality when the task is, for example, to preview an image), etc., but this disclosure is not limited in this respect.

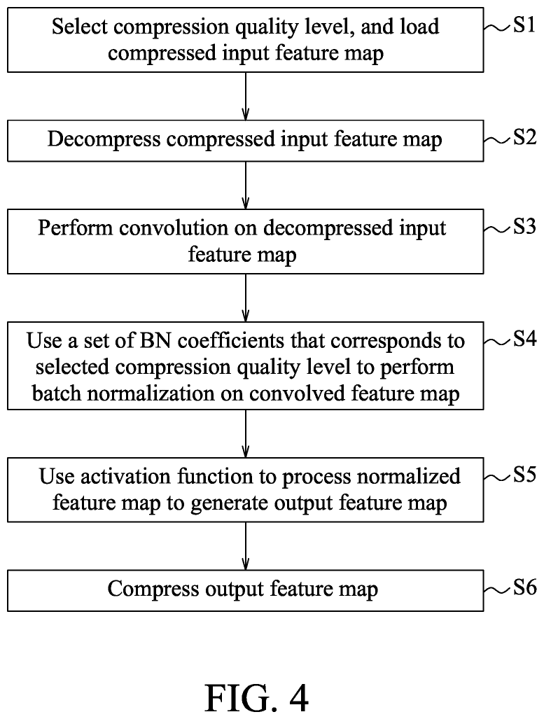

Referring to FIG. 4, operation of the computing unit 11 to achieve flexible feature compression will be described with respect to a single neuron layer for the sake of brevity. In practice, the described operation may be implemented in multiple neuron layers.

In step S1, the computing unit 11 selects one of the predetermined compression quality levels for the neuron layer, and loads a compressed input feature map that corresponds to the neuron layer from the external memory device 2. The compressed input feature map is an output of the last neuron layer (i.e., one of the neuron layers that is immediately previous to the neuron layer), and has been compressed using one of the predetermined compression quality levels that is the same as the predetermined compression quality level selected for the neuron layer. In this embodiment, the compression is performed using the JPEG or JPEG-like (e.g., some operations of the JPEG compression may be omitted, such as header encoding) compression method, which is a lossy compression. It is noted that the compressed input feature map may be composed of a plurality of compressed portions, and the computing unit 11 may load one of the compressed portions at a time for subsequent steps because of the limited memory capacity of the accelerator 1.

In step S2, the computing unit 11 decompresses the compressed input feature map with respect to the selected one of the predetermined compression quality levels to obtain a decompressed input feature map.

In step S3, the computing unit 11 loads, from the external memory device 2, a kernel map set that corresponds to the neuron layer and that has been trained with respect to each of the predetermined compression quality levels, and uses the kernel map set to perform convolution on the decompressed input feature map to generate a convolved feature map.

In step S4, the computing unit 11 loads one of the sets of batch normalization coefficients that has been trained with respect to the selected one of the predetermined compression quality levels from the external memory device 2, and uses the loaded set of batch normalization coefficients to perform batch normalization on the convolved feature map to generate a normalized feature map for use by the next neuron layer, which is one of the neuron layers that immediately follows the neuron layer.

In step S5, the computing unit 11 uses an activation function to process the normalized feature map to generate an output feature map. The activation function may be, for example, a rectified linear unit (ReLU), a leaky ReLU, a sigmoid linear unit (SiLU), a Gaussian error linear unit (GELU), other suitable functions, or any combination thereof.

In step S6, the computing unit 11 selects one of the predetermined compression quality levels for the next neuron layer, compresses the output feature map using said one of the predetermined compression quality level that is selected for the next neuron layer, and stores the output feature map thus compressed into the external memory device 2. The output feature map thus compressed would serve as the compressed input feature map for the next neuron layer. Step S6 is a data compression procedure that uses the JPEG or JPEG-like compression method in this embodiment, but this disclosure is not limited to any specific compression method.

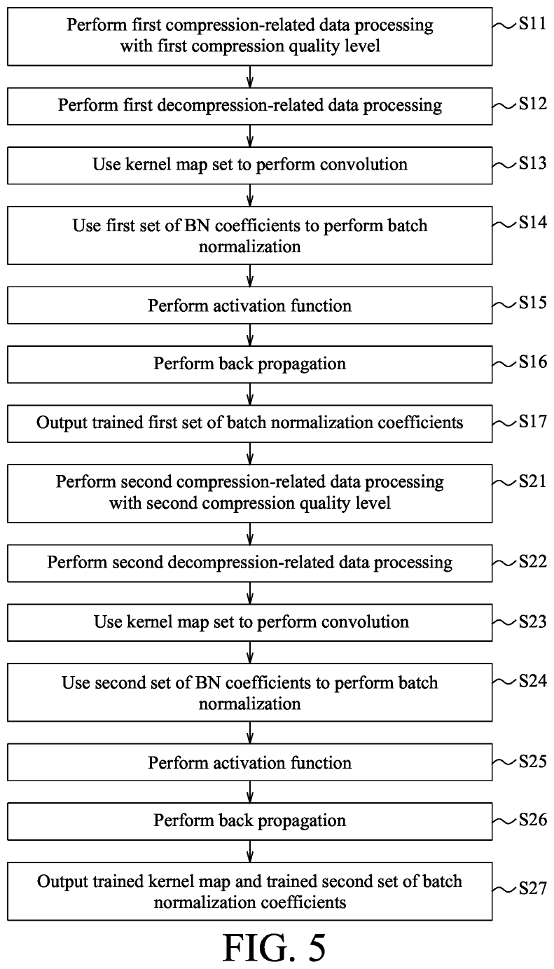

FIG. 5 is a flow chart illustrating steps of an embodiment of a method for training a neural network as used in the aforesaid neural network system, which has flexible feature compression capability. For the sake of brevity, the steps may be described with respect to a single neuron layer (referred to as “the specific neuron layer” hereinafter) of the neural network, but the steps can be applied to other neuron layers as well.

Through steps S11 to S16, the accelerator 1 trains the neural network based on a first compression quality setting that indicates or corresponds to a first compression quality level (which is one of the predetermined compression quality levels), where a first set of batch normalization coefficients that corresponds to the first compression quality level is used in the specific neuron layer to have a kernel map set of the specific neuron layer and the first set of batch normalization coefficients trained. Subsequently, the accelerator 1 outputs the kernel map set and the first set of batch normalization coefficients that have been trained through steps S11 to S16 for use by the neural network when the neural network is executed to perform decompression and multiplication-and-accumulation (e.g., convolution) on a to-be-processed compressed feature map substantially based on the first compression quality level in the specific neuron layer. The term “substantially” as used herein may generally mean that an error of a given value or range is within 20%, preferably within 10%. For example, in practice, one may use the kernel map set and the first set of batch normalization coefficients that were trained with respect to a compression quality level of 80 to perform decompression and multiplication-and-accumulation (e.g., convolution) on the to-be-processed compressed feature map based on a compression quality level of 75, which falls within the aforesaid interpretation of “substantially” because the error would be (80−75)/80=6.25%.

In step S11, the accelerator 1 performs first compression-related data processing on a first input feature map to obtain a first processed feature map, wherein the first compression-related data processing is related to data compression with the first compression quality level.

In step S12, the accelerator 1 performs first decompression-related data processing on the first processed feature map to obtain a second processed feature map, wherein the first decompression-related data processing is related to data decompression and corresponds to the first compression quality level.

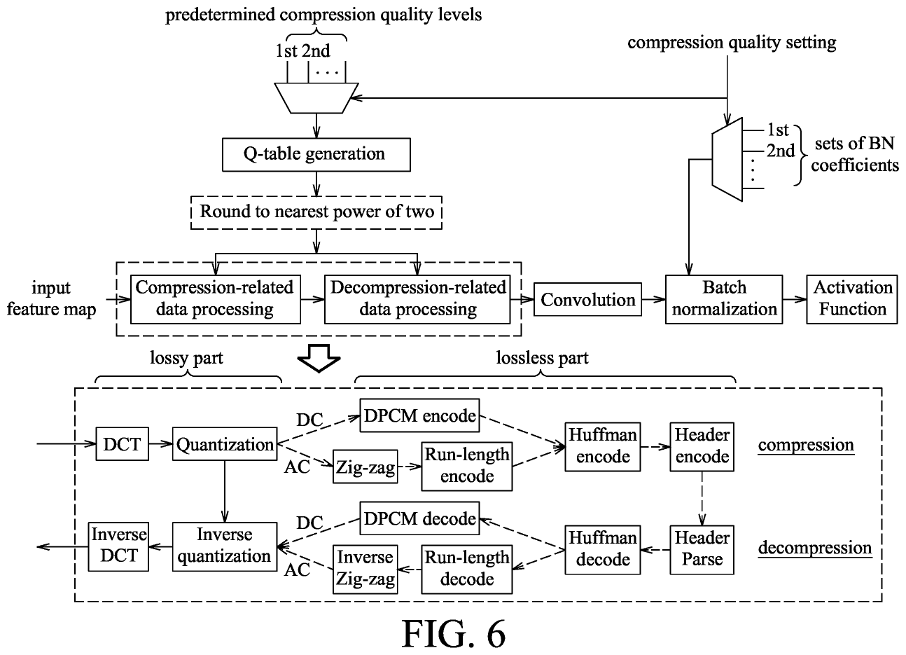

Referring to FIG. 6, in this embodiment, the accelerator 1 uses paired compression and decompression of the JPEG algorithm as the first compression-related data processing and the first decompression-related data processing, respectively, but this disclosure is not limited to using the JPEG algorithm. At first, the accelerator 1 generates a quantization table (Q-table) based on the first compression quality level (i.e., one of the predetermined compression quality levels that is indicated by the first compression quality setting), and uses the Q-table thus generated to perform the first compression-related data processing and the first decompression-related data processing. Optionally, the accelerator 1 may round elements of the Q-table to the nearest power of two, so as to simplify the subsequent quantization procedure in the first compression-related data processing and the subsequent inverse quantization procedure in the first decompression-related data processing. The JPEG compression (i.e., compression of the JPEG algorithm) is a lossy compression that can be divided into a first part, and a second part following the first part. The first part is a lossy part that includes discrete cosine transform (DCT) and quantization, where quantization is a lossy operation. The second part is a lossless part that includes differential pulse code modulation (DPCM) encoding on DC coefficients, zig-zag scanning and run-length encoding on AC coefficients, Huffman encoding, and header encoding, each of which is a lossless operation (i.e., the second part includes only lossless operations). The paired decompression of the JPEG algorithm includes inverse operations of the abovementioned operations of the compression, such as header parsing, Huffman decoding, run-length decoding and inverse zig-zag scanning on AC coefficients, DPCM decoding on DC coefficients, inverse quantization and inverse DCT. Since one purpose of training the neural network is to have the kernel map set and the sets of batch normalization coefficients properly trained, and the lossless second part of the compression and the corresponding part of the decompression have no impact on the training result, the second part of the compression and the corresponding part of the decompression can be omitted during the training, so as to reduce the overall time required to train the neural network. In other words, the first compression-related data processing may include only the first part of the JPEG compression (e.g., consisting of only the DCT and the quantization) in this embodiment, and the first decompression-related data processing may include only the inverse operations of the first part of the JPEG compression (e.g., consisting of only the inverse quantization and the inverse DCT). However, when the neural network that has been trained is used in a practical application, the first part and some of the second part of the compression would be performed to achieve the purpose of reducing the data size, and so do the corresponding parts of the decompression.

In step S13, the accelerator 1 uses the kernel map set to perform convolution on the second processed feature map to generate a first convolved feature map.

In step S14, the accelerator 1 uses the first set of batch normalization coefficients to perform batch normalization on the first convolved feature map to obtain a first normalized feature map for use by the next neuron layer, which is one of the neuron layers that immediately follows the specific neuron layer. The first set of batch normalization coefficients may include a set of scaling coefficients and a set of offset coefficients that are used to perform scaling and offset in the batch normalization performed on the first convolved feature map.

In step S15, the accelerator 1 uses an activation function to process the first normalized feature map, and the first normalized feature map thus processed is used as an input feature map to the next neuron layer.

In step S16, after the neural network generates a final output, the accelerator 1 performs back propagation on the neural network that was used in step S11 to S15 to modify, for each neuron layer, the corresponding kernel map set and the corresponding set of batch normalization coefficients (e.g., the kernel map set that was used in step S13 and the first set of batch normalization coefficients that was used in step S14 for the specific neuron layer).

Accordingly, each kernel map in the kernel map set and the first set of batch normalization coefficients for the specific neuron layer have been trained with respect to the first compression quality level.

After the neural network has been trained using a batch of training data for the first compression quality level, the accelerator 1 outputs the kernel map set (optional) and the first set of batch normalization coefficients of the specific neuron layer that are adapted for the first compression quality level (step S17). Referring to FIGS. 5 and 6 again, a second compression quality setting is then applied to select another predetermined compression quality level (referred to as “second compression quality level” hereinafter) that is different from the first compression quality level, where one of the first compression quality level and the second compression quality level is a lossy compression level, or both of the first compression quality level and the second compression quality level are lossy compression levels. Through steps S21 to S26, the accelerator 1 (see FIG. 2) trains the neural network based on the second compression quality setting that corresponds to the second compression quality level, where the kernel map set that has been trained with respect to the first compression quality level through steps S11 to S16 and a second set of batch normalization coefficients that corresponds to the second compression quality level are used in the specific neuron layer, so the kernel map set that has been trained with respect to the first compression quality level and the second set of batch normalization coefficients are trained with respect to the second compression quality level. Subsequently, the accelerator 1 outputs the kernel map set and the second set of batch normalization coefficients, where the kernel map has been trained with respect to the first compression quality level through steps S11 to S16 and with respect to the second compression quality level through steps S21 to S26 for use by the neural network when the neural network is executed to perform decompression and multiplication-and-accumulation on the to-be-processed compressed feature map substantially based on any one of the first compression quality level and the second compression quality level in the specific neuron layer, and the second set of batch normalization coefficients has been trained with respect to the second compression quality level through steps S21 to S26 for use by the neural network when the neural network is executed to perform decompression and multiplication-and-accumulation on the to-be-processed compressed feature map substantially based on the second compression quality level in the specific neuron layer.

In step S21, the accelerator 1 performs second compression-related data processing on a second input feature map to obtain a third processed feature map, where the second compression-related data processing is related to data compression with the second compression quality level.

In step S22, the accelerator 1 performs second decompression-related data processing on the second processed feature map to obtain a fourth processed feature map, where the second decompression-related data processing is related to data decompression and the second compression quality level.

The accelerator 1 generates a Q-table based on the second compression quality level, and uses the Q-table thus generated to perform the second compression-related data processing and the second decompression-related data processing. Details of the second compression-related data processing and the second decompression-related data processing are similar to those of the first compression-related data processing and the first decompression-related data processing, and are not repeated herein for the sake of brevity.

In step S23, the accelerator 1 uses the kernel map set that has been modified in step S16 to perform convolution on the fourth processed feature map to generate a second convolved feature map.

In step S24, the accelerator 1 uses the second set of batch normalization coefficients to perform batch normalization on the second convolved feature map to obtain a second normalized feature map for use by the next neuron layer. The second set of batch normalization coefficients may include a set of scaling coefficients and a set of offset coefficients that are used to perform scaling and offset in the batch normalization performed on the second convolved feature map.

In step S25, the accelerator 1 uses the activation function to processes the second normalized feature map, and the second normalized feature map thus processed is used as an input feature map to the next neuron layer.

In step S26, after the neural network generates a final output, the accelerator 1 performs back propagation on the neural network that was used in steps S21 to S25 to modify, for each neuron layer, the corresponding kernel map set and the corresponding set of batch normalization coefficients (e.g., the kernel map set that has been modified in step S16 and that was used in step S23, and the second set of batch normalization coefficients that was used in step S24 for the specific neuron layer).

Accordingly, each kernel map in the kernel map set and the second set of batch normalization coefficients for the specific neuron layer have been trained with respect to the second compression quality level. In step S27, the accelerator 1 outputs the kernel map set of the specific neuron layer that is adapted for the first compression quality level and the second compression quality level, and the second set of batch normalization coefficients of the specific neuron layer that is adapted for the second compression quality level.

In some embodiments, steps S11 to S16 may be iteratively performed with multiple mini-batches of training datasets, and/or steps S21 to S26 may be iteratively performed with multiple mini-batches of training datasets. A mini-batch is a subset of a training dataset. In some embodiments, a mini-batch may include 256, 512, 1024, 2048, 4096, or 8192 training samples, but this disclosure is not limited to these specific numbers. Batch Gradient Descent training is one special case with mini-batch size being set to the total number of examples in the training dataset. Stochastic Gradient Descent (SGD) training is another special case with mini-batch size set to 1. In some embodiments, iterations of steps S11 to S16 and iterations of steps S21 to S26 do not need to be performed in any particular order. In other words, the iterations of steps S11 to S16 and the iterations of steps S21 to S26 may be interleavingly performed (e.g., in the order of S11-S16, S21-S26, S11-S16, S21-S26 . . . , with S17 and S27 at last). It is noted that step S17 is not necessarily performed prior to steps S21-S26, and can be performed together with step S27 in other embodiments, and this disclosure is not limited to specific orders of step S17 and steps S21-S26.

As a result, for the specific neuron layer, the kernel map set has been trained with respect to both of the first compression quality level and the second compression quality level, the first set of batch normalization coefficients has been trained with respect to the first compression quality level, and the second set of batch normalization coefficients has been trained with respect to the second compression quality level. If needed, the specific neuron layer can be trained with respect to other compression quality levels in a similar way, so the kernel map set of the specific neuron layer is trained with respect to additional compression quality levels, and the specific neuron layer includes additional sets of batch normalization coefficients that are respectively trained with respect to the additional compression quality levels, and this disclosure is not limited to only two compression quality levels. In addition, each neuron layer of the neural network can be trained in the same manner as the specific neuron layer, and as a result, the neural network is adapted for multiple compression quality levels, and has flexible feature compression capability.

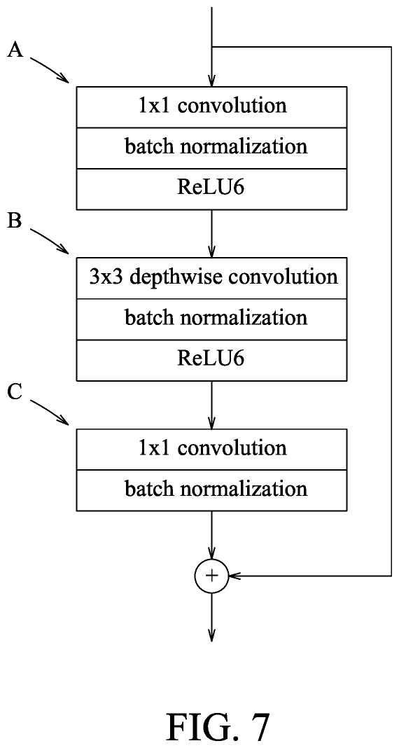

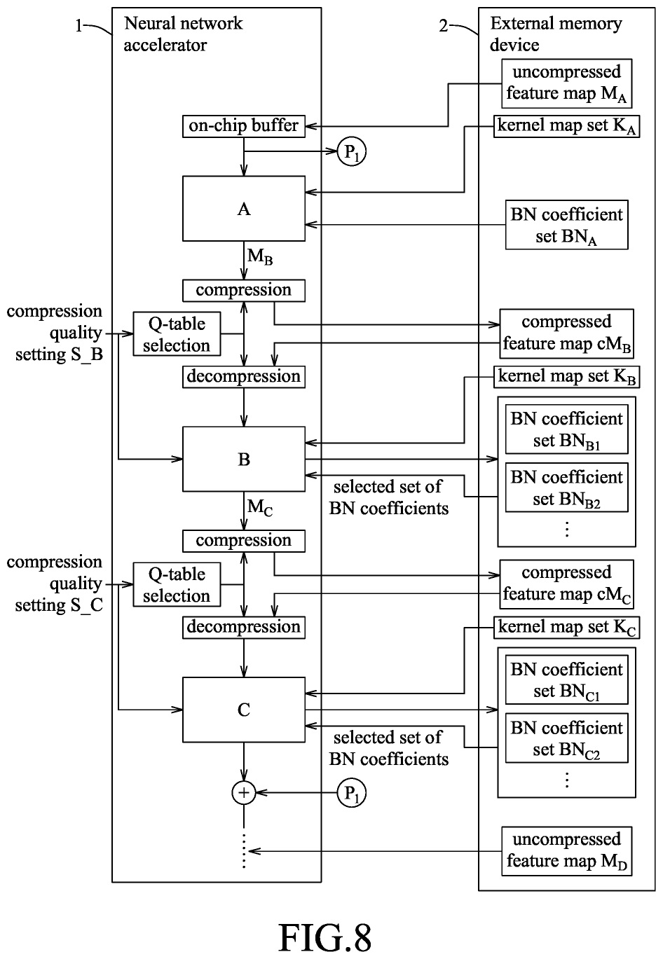

FIG. 7 exemplarily shows a bottleneck residual block of a MobileNet architecture, and FIG. 8 illustrates how the bottleneck residual block could be realized using the embodiment of the neural network system, where blocks A, B and C in FIG. 8 correspond to blocks A, B and C in FIG. 7, respectively. The accelerator 1 loads an uncompressed feature map M_{A} from the external memory device 2 into an on-chip buffer thereof, and loads a kernel map set K_{A} to perform 1×1 convolution (see “1×1 convolution” of block A in FIG. 7) on the uncompressed feature map M_{A}, followed by performing batch normalization and the function of ReLU6 (see “batch normalization” and “ReLU6” of block A in FIG. 7), so as to generate a feature map MB. The accelerator 1 loads the BN coefficients set BNA to perform the batch normalization. Then, the accelerator 1 selects a Q-table that corresponds to one of the predetermined compression quality levels as indicated by the compression quality setting S_B to compress the feature map MB, and stores the compressed feature map cM_{B} into the external memory device 2. When the flow goes to block B, the accelerator 1 loads the compressed feature map cM_{B} from the external memory device 2, and uses the Q-table that is selected based on the compression quality setting S_B to decompress the compressed feature map cM_{B}. Operations of block B and block C are similar to those of block A, so details thereof are not repeated herein for the sake of brevity. After the batch normalization of block C, the accelerator 1 loads the uncompressed feature map M_{A} and aggregates (e.g., sums up or concatenates) the uncompressed feature map M_{A} and the output of block C together to generate and store an uncompressed feature map MD into the external memory device 2. It is noted that the compression quality settings S_B, S_C may indicate either the same compression quality level or different compression quality levels, and this disclosure is not limited in this respect.

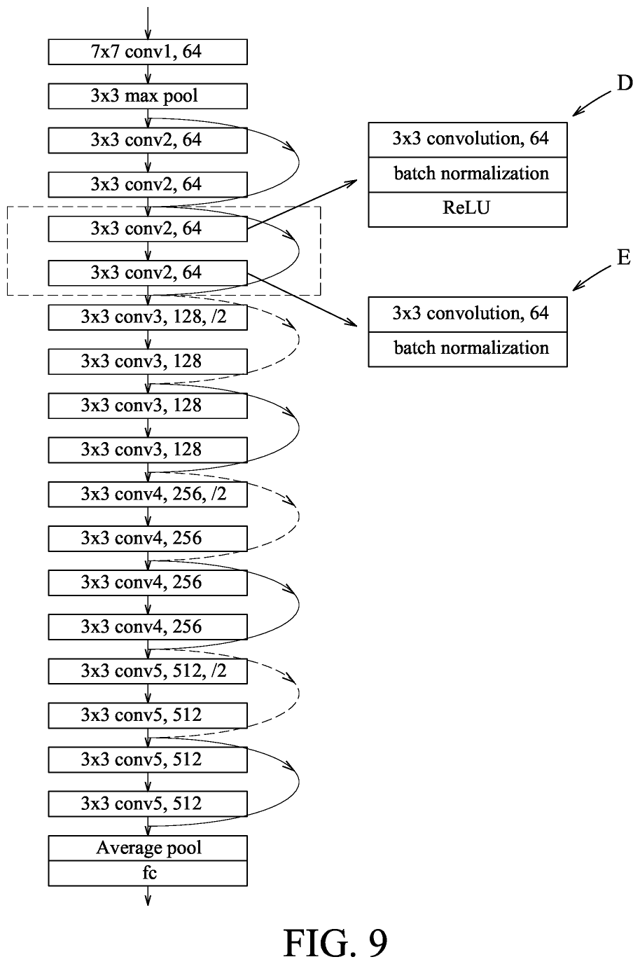

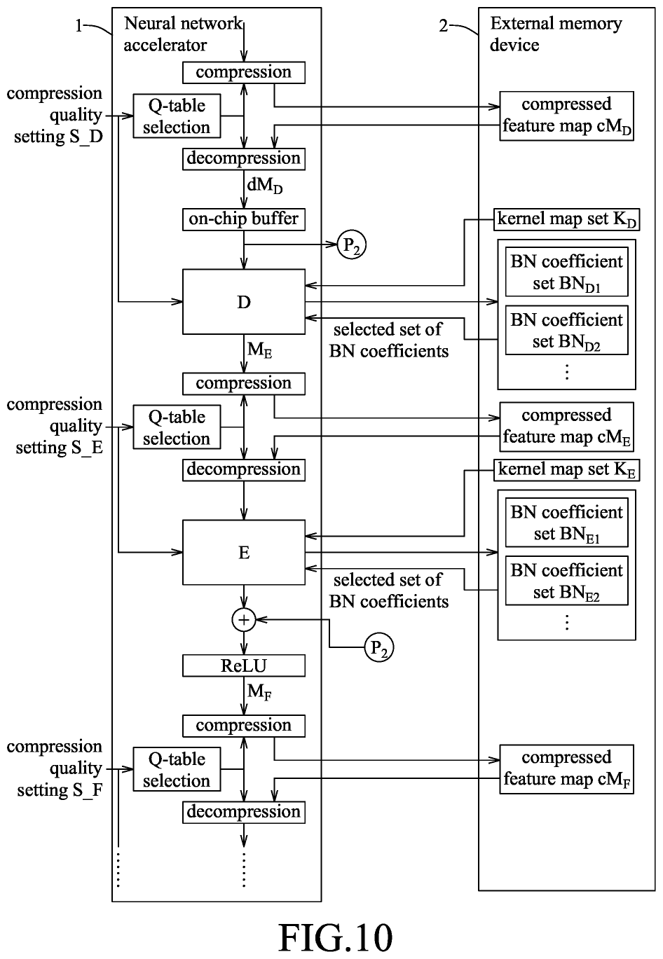

FIG. 9 exemplarily shows a ResNet architecture, and FIG. 10 illustrates a part of the ResNet architecture (the part enclosed by dotted lines in FIG. 9) that is realized using the embodiment of the neural network system, where blocks D and E in FIG. 10 correspond to blocks D and E in FIG. 9, respectively. The accelerator 1 loads a compressed feature map cM_{D} that was compressed with a compression quality level as indicated by the compression quality setting S_D from the external memory device 2, uses a Q-table that is selected based on the compression quality setting S_D to decompress the compressed feature map cM_{D}, and stores the decompressed feature map dM_{D} into an on-chip buffer thereof. Then, the accelerator 1 loads a kernel map set KD to perform 3×3 convolution (see “3×3 convolution, 64” of block D in FIG. 9) on the decompressed feature map dM_{D}, followed by performing batch normalization and the function of ReLU (see “batch normalization” and “ReLU” of block D in FIG. 9), so as to generate a feature map ME. The accelerator 1 loads one of the BN coefficients sets (BN_{D1}, BN_{D2} . . . ) that corresponds to one of the predetermined compression quality levels as indicated by the compression quality setting S_D, so as to perform the batch normalization. Then, the accelerator 1 selects a Q-table that corresponds to one of the predetermined compression quality levels as indicated by the compression quality setting S_E to compress the feature map ME, and stores the compressed feature map cM_{E} into the external memory device 2. When the flow goes to block E, the accelerator 1 loads the compressed feature map cM_{E} from the external memory device 2, and uses the Q-table that is selected based on the compression quality setting S_E to decompress the compressed feature map cM_{E} for use by block E. Operations of block E are similar to those of block D, so details thereof are not repeated herein for the sake of brevity. After the batch normalization of block E, the accelerator 1 loads the decompressed feature map dM_{D} from the on-chip buffer, and aggregates (e.g., sums up or concatenates) the decompressed feature map dM_{D} and the output of block E together to acquire a resultant feature map. Then, the accelerator 1 performs the function of ReLU on the resultant feature map to generate a feature map MF, uses a Q-table that is selected based on the compression quality setting S_F to compress the feature map MF, and stores the compressed feature map cM_{F} into the external memory device 2. It is noted that the compression quality settings S_D, S_E, S_F may indicate either the same compression quality level or different compression quality levels, and this disclosure is not limited in this respect.

Table 1 compares the embodiment with prior art using two ResNet neural networks denoted by ResNet-A and ResNet-B, where the prior art uses only one set of batch normalization coefficients for different compression quality levels in a single neuron layer, while the embodiment of this disclosure uses different sets of batch normalization coefficients for different compression quality levels in a single neuron layer. Four compression levels corresponding to four quality levels were tested. Taking ResNet-A, for example, the prior art achieves 69.7%, 66.8%, 42.6%, and 14.9% accuracy, depending on the four compression levels, respectively. In comparison, this embodiment achieves 69.8%, 69.1%, 66.6%, and 64%, which are up to 49.1% better than the baseline (64%-14.9%=49.1% at quality level 50). Experiments on ResNet-B also show that this embodiment makes one neural network adapt to multiple (four in the example) compression quality levels better than the prior art.

TABLE 1

| Top-1 Accuracy | | ResNet-A | | ResNet-B | |
|---|---|---|---|---|---|
| on ImageNet-1K | | | This | | This |
| Classification (%) | | Prior Art | embodiment | Prior Art | embodiment |
| Compression | 100 | 69.7 | 69.8 | 76 | 76.1 |
| Quality | 90 | 66.8 | 69.1 | 70.7 | 75.6 |
| Level | 70 | 42.6 | 66.6 | 16.8 | 72.6 |
| | 50 | 14.9 | 64 | 3.4 | 69.9 |

To sum up, the embodiment of the neural network system according to this disclosure includes, for a single neuron layer, a kernel map set that has been trained with respect to multiple predetermined compression quality levels, and multiple sets of batch normalization coefficients that have been trained respectively for the multiple predetermined compression quality levels, and thus the neural network system has flexible feature compression capability. In some embodiments, during the training of the neural network, the compression-related training includes only the lossy part of the full compression procedure (i.e., the lossless part is omitted), and the decompression-related training includes only the inverse operations of the lossy part of the full compression procedure, so the overall time required for the training can be reduced.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for training a neural network that includes multiple neuron layers, one of which includes a weight set and has a data compression procedure that uses a data compression-decompression algorithm, said method comprising steps of:
A) by a neural network accelerator, training the neural network based on a first compression setting that corresponds to a first compression quality level, where a first set of batch normalization coefficients that corresponds to the first compression quality level is used in said one of the neuron layers during the training of the neural network in step A);
B) outputting the first set of batch normalization coefficients that have been trained in step A) for use by the neural network when the neural network is executed to perform decompression and multiplication-and-accumulation on a to-be-processed compressed feature map substantially based on the first compression quality level in said one of the neuron layers;
C) by the neural network accelerator, training the neural network based on a second compression setting that corresponds to a second compression quality level different from the first compression quality level, where the weight set that has been trained in step A) and a second set of batch normalization coefficients that corresponds to the second compression quality level are used in said one of the neuron layers during the training of the neural network in step C); and
D) outputting the weight set that has been trained in both of step A) and step C) for use by the neural network when the neural network is executed to perform decompression and multiplication-and-accumulation on the to-be-processed compressed feature map substantially based on any one of the first compression quality level and the second compression quality level in said one of the neuron layers, and the second set of batch normalization coefficients that has been trained in step C) for use by the neural network when the neural network is executed to perform decompression and multiplication-and-accumulation on the to-be-processed compressed feature map substantially based on the second compression quality level in said one of the neuron layers;
wherein at least one of the first compression quality level or the second compression quality level is a lossy compression level.

2. The method as claimed in claim 1, wherein step A) includes sub-steps of:
A-1) performing first compression-related data processing on a first input feature map to obtain a first processed feature map, wherein the first compression-related data processing is related to the data compression-decompression algorithm in which the first compression quality level is used; and
A-2) performing first decompression-related data processing on the first processed feature map to obtain a second processed feature map, wherein the first decompression-related data processing is related to data decompression and the first compression quality level;
A-3) using the weight set to perform an operation of multiplying and accumulating on the second processed feature map to generate a first computed feature map;
A-4) using the first set of batch normalization coefficients to perform batch normalization on the first computed feature map to obtain a first normalized feature map for use by a next neuron layer, wherein the next neuron layer is one of the neuron layers that immediately follows said one of the neuron layers; and
A-5) performing back propagation on the neural network that was used in sub-step A-1) to sub-step A-4) to modify the weight set and the first set of batch normalization coefficients; and
wherein step C) includes sub-steps of:
C-1) performing second compression-related data processing on a second input feature map to obtain a third processed feature map, wherein the second compression-related data processing is related to the data compression-decompression algorithm in which the second compression quality level is used;
C-2) performing second decompression-related data processing on the third processed feature map to obtain a fourth processed feature map, wherein the second decompression-related data processing is related to data decompression and the second compression quality level;
C-3) using the weight set that has been modified in sub-step A-5) to perform an operation of multiplying and accumulating on the fourth processed feature map to generate a second computed feature map;
C-4) using the second set of batch normalization coefficients to perform batch normalization on the second computed feature map to obtain a second normalized feature map for use by the next neuron layer; and
C-5) performing back propagation on the neural network that was used in sub-step C-1) to sub-step C-4) to modify the weight set that has been modified in sub-step A-5) and the second set of batch normalization coefficients.

3. The method as claimed in claim 2, wherein the data compression-decompression algorithm includes a lossy part that includes a lossy operation, and a lossless part that follows the lossy operation of the lossy part, and each of the first compression-related data processing and the second compression-related data processing includes only the lossy part of the lossy compression; and
wherein each of the first decompression-related data processing and the second decompression-related data processing includes only inverse operations of the lossy part of the lossy compression.

4. The method as claimed in claim 3, wherein each of the first compression-related data processing and the second compression-related data processing consists of only a discrete cosine transform (DCT) and a quantization operation.

5. The method as claimed in claim 2, wherein the first set of batch normalization coefficients includes a first set of scaling coefficients that are used to perform scaling in the batch normalization performed on the first computed feature map, and a first set of offset coefficients that are used to perform offset in the batch normalization performed on the first computed feature map; and
wherein the second set of batch normalization coefficients includes a second set of scaling coefficients that are used to perform scaling in the batch normalization performed on the second computed feature map, and a second set of offset coefficients that are used to perform offset in the batch normalization performed on the second computed feature map.

6. The method as claimed in claim 1, wherein step A) and step C) are iteratively and interleavingly performed using multiple mini-batches of training datasets.

7. The method as claimed in claim 1, wherein the neural network is for one of artificial intelligence (AI) de-noising, AI style transfer, AI temporal super resolution, AI spatial super resolution, and AI image generation.

8. A neural network system, comprising:
a neural network accelerator that is configured to execute the neural network that has been trained using the method as claimed in claim 1; and
a memory device that is accessible to said neural network accelerator, and that stores the weight set which has been trained in the method, the first set of batch normalization coefficients which has been trained in the method, and the second set of batch normalization coefficients which has been trained in the method;
wherein said neural network accelerator is configured
to select one of the first compression quality level and the second compression quality level for said one of the neuron layers,
to store into said memory device a compressed input feature map that corresponds to said one of the neuron layers and that was compressed with the selected one of the first compression quality level and the second compression quality level,
to load the compressed input feature map from said memory device for said one of the neuron layers,
to decompress the compressed input feature map with respect to the selected one of the first compression quality level and the second compression quality level to obtain a decompressed input feature map,
to load the weight set from said memory device,
to use the weight set to perform an operation of multiplying and accumulating on the decompressed input feature map to generate a computed feature map,
to load one of the first set of batch normalization coefficients and the second set of batch normalization coefficients that corresponds to the selected one of the first compression quality level and the second compression quality level from said memory device, and
to use the loaded one of the first set of batch normalization coefficients and the second set of batch normalization coefficients to perform batch normalization on the computed feature map to generate a normalized feature map for use by the next neuron layer.

9. The neural network system as claimed in claim 8, wherein said neural network accelerator is further configured
to use an activation function to process the normalized feature map to generate an output feature map,
to select one of the first compression quality level and the second compression quality level for the next neuron layer,
to compress the output feature map with one of the first compression quality level and the second compression quality level thus selected for the next neuron layer, and
to store the output feature map thus compressed into said memory device.

10. The neural network system as claimed in claim 9, wherein said memory device includes an external memory chip storing said compressed input feature map and the output feature map thus compressed.

11. The neural network system as claimed in claim 8, wherein the first set of batch normalization coefficients includes a first set of scaling coefficients and a first set of offset coefficients that are used to perform scaling and offset in the batch normalization when the first set of batch normalization coefficients is the loaded one of the first set of batch normalization coefficients and the second set of batch normalization coefficients; and
wherein the second set of batch normalization coefficients includes a second set of scaling coefficients and a second set of offset coefficients that are used to perform scaling and offset in the batch normalization when the second set of batch normalization coefficients is the loaded one of the first set of batch normalization coefficients and the second set of batch normalization coefficients.

12. The neural network system as claimed in claim 8, wherein said neural network accelerator is configured to select one of the first compression quality level and the second compression quality level for said one of the neuron layers based on at least one factor selected from among first to seventh factors; and
wherein the first factor is a work load of said neural network accelerator, the second factor is a temperature of said neural network accelerator, the third factor is a battery level of a battery device when power of said neural network system is supplied by the battery device, the fourth factor is available storage space of said memory device, the fifth factor is an available bandwidth of said memory device, the sixth factor is a length of time set for completing a task to be done by said neural network, and the seventh factor is a type of the task to be done by said neural network.

13. The neural network system as claimed in claim 8, wherein the neural network is for one of artificial intelligence (AI) de-noising, AI style transfer, AI temporal super resolution, AI spatial super resolution, and AI image generation.

14. A neural network system, comprising:
a neural network accelerator that is configured to cause a neural network that includes multiple neuron layers to perform corresponding operations; and
a memory device that is accessible to said neural network accelerator, and that stores a weight set corresponding to one of the neuron layers, and multiple sets of batch normalization coefficients corresponding to said one of the neuron layers;
wherein the weight set is adapted to multiple compression quality levels, and each of the sets of batch normalization coefficients is adapted for a respective one of the compression quality levels; and
wherein said neural network accelerator is configured
to select one of the compression quality levels for said one of the neuron layers,
to store into said memory device a compressed input feature map that corresponds to said one of the neuron layers and that was compressed with the selected one of the compression quality levels,
to load the compressed input feature map from said memory device for said one of the neuron layers,
to decompress the compressed input feature map with respect to the selected one of the compression quality levels to obtain a decompressed input feature map,
to load the weight set from said memory device,
to use the weight set to perform an operation of multiplying and accumulating on the decompressed input feature map to generate a computed feature map,
to load one of the sets of batch normalization coefficients that is adapted for the selected one of the compression quality levels from said memory device, and
to use the loaded one of the sets of batch normalization coefficients to perform batch normalization on the computed feature map to generate a normalized feature map for use by a next neuron layer, which is one of the neuron layers that immediately follows said one of the neuron layers.

15. The neural network system as claimed in claim 14, wherein said neural network accelerator is further configured
to use an activation function to process the normalized feature map to generate an output feature map,
to select one of the compression quality levels for the next neuron layer,
to compress the output feature map with one of the compression quality levels thus selected for the next neuron layer, and
to store the output feature map thus compressed into said memory device.

16. The neural network system as claimed in claim 15, wherein said memory device includes an external memory chip storing said compressed input feature map and the output feature map thus compressed.

17. The neural network system as claimed in claim 14, wherein each of the sets of batch normalization coefficients includes a set of scaling coefficients and a set of offset coefficients that are used to perform scaling and offset in the batch normalization when the set of batch normalization coefficients is the loaded one of the sets of the batch normalization coefficients.

18. The neural network system as claimed in claim 14, wherein said neural network accelerator is configured to select one of the compression quality levels for said one of the neuron layers based on at least one factor selected from among first to seventh factors; and
wherein the first factor is a work load of said neural network accelerator, the second factor is a temperature of said neural network accelerator, the third factor is a battery level of a battery device when power of said neural network system is supplied by the battery device, the fourth factor is available storage space of said memory device, the fifth factor is an available bandwidth of said memory device, the sixth factor is a length of time set for completing a task to be done by said neural network, and the seventh factor is a type of the task to be done by said neural network.

19. The neural network system as claimed in claim 14, wherein the neural network is for one of artificial intelligence (AI) de-noising, AI style transfer, AI temporal super resolution, AI spatial super resolution, and AI image generation.

20. The neural network system as claimed in claim 14, wherein said one of the neuron layers is a convolution layer.
